(19) United States
(12) Patent Application Publication
(10) Pub. No.: US 2022/0332642 A1
(43) Pub. Date: Oct. 20, 2022

(54) METHOD OF INERTING EXCAVATION SLUDGE

(71) Applicant: EIFFAGE GC INFRA LINEAIRES, Velizy-Villacoublay (FR)

(72) Inventors: Laurence BOULANGÉ, CHAPAREILLAN (FR); Florian DOOM, MONTÉVRAIN (FR); Marina DA CRUZ GOMES, SAINT DENIS (FR)

(73) Assignee: EIFFAGE GC INFRA LINEAIRES, Velizy-Villacoublay (FR)

(21) Appl. No.: 17/722,557

(22) Filed: Apr. 18, 2022

(30) Foreign Application Priority Data
Apr. 19, 2021 (FR) 2104054

(51) Int. Cl. C04B 18/12; C04B 26/26; C02F 11/147; B01D 11/04

(52) U.S. Cl. CPC C04B 18/12; C04B 26/26; C02F 11/147; B01D 11/0492; C02F 2103/10

(57) ABSTRACT

A process for rendering excavation material inert for the purpose of their analysis, of their storage and/or of their valorisation. The process for inerting the excavation material includes adding an organic acid, of a complexing agent or of a diaminotetracarboxylic acid to the excavation material, the complexing agent being chosen from a sugar alcohol, a cationic surface-active agent and their mixtures. Also, a method of determining the concentration by weight of a polluting inorganic element included in an excavated material, a method of storage of the inert excavation material, and a method of valorising the inerted material.

### FIELD

The present disclosure relates to the field of the characterization of excavation sludges extracted by tunnelling machines, in particular of the determination of the concentration by weight of polluting inorganic element(s) in these excavation sludges.

### BACKGROUND

During any construction on or under the ground, in particular during the digging of tunnels, the development of the ground takes place by excavation. Amounts of excavation material are then extracted which depend on the scale and on the type of works. Typically, a tunnelling machine used to excavate a tunnel during the construction of an underground railway line produces approximately 800 tonnes per day of excavation sludges.

The excavation sludges thus extracted contain varied chemical entities. Some chemical entities originate from the composition of the rock or sand; the term used is then matrix. Other chemical entities are present in a smaller amount; the term used is then traces. When the traces exhibit a toxicity, they are referred to as pollutants. There exists endogenous pollution, originating from the geological environment of the removal, and pollution related to local human activity, at the surface. These chemical entities can represent a risk to the environment when the excavation sludges are stored after having been extracted. Before storing these excavation sludges, it is thus necessary to determine their degree of contamination. The determination of this degree of contamination makes it possible to direct the sludges into one of the three existing treatment procedures. These three treatment procedures are as follows:

1) Inert sludges are stored in order to be valorised,

2) Slightly contaminated sludges are stored in specialized landfills (the subsoil of which does not make possible flow into ground waters),

3) Contaminated sludges are sent into a valorised procedure for recovering the polluting elements.

The selection of the appropriate treatment procedure depends on the concentration by weight of pollutant in the excavation sludges. The threshold values for limiting concentration by weight of pollutant to be observed are set by legislative texts. In France, they are the Decision No. 2003/33/EC of 19 Dec. 2002, establishing criteria and procedures for the acceptance of waste at landfills, and decrees of 30 Dec. 2002, relating to the storage of hazardous waste, and of 12 Dec. 2014, relating to the conditions for the acceptance of inert waste [ . . . ]. According to this Decision and these decrees, the limiting values for concentration by weight of each of the polluting inorganic elements to be detected are among the most exacting in Europe. As indicated in Table 1 below, these limiting values are very low and highly scattered.

If the concentration by weight of each polluting inorganic element contained in the excavation sludge is lower than the IWSI limiting value indicated in Table 1, then the excavation sludge is regarded as inert. It can then be stored in inert waste storage installations in order to be valorised, for example as building material or for landscape valorising.

If the concentration by weight of at least one of the polluting inorganic elements contained in the excavation sludge is between the IWSI and NHWSI limiting values indicated in Table 1, then the excavation sludge is regarded as slightly contaminated. It can then be stored in non-hazardous waste storage installations.

If the concentration by weight of at least one of the polluting inorganic elements contained in the excavation sludge is between the NHWSI and HWSI limiting values indicated in Table 1, then the excavation sludge is regarded as contaminated. It is then stored in hazardous waste storage installations. It can be decontaminated therein in order to recover and valorise the polluting inorganic elements.

TABLE 1
Summary of the pollutants to be detected by leaching and
their limiting value of concentration by weight

| | IWSI* | NHWSI** | HWSI** |
|---|---|---|---|
| Polluting inorganic | limiting | limiting | limiting |
| elements to | value | value | value |
| be detected | Concentration by weight in mg/kg of solids | | |
| Antimony (Sb) | 0.06 | 0.7 | 5 |
| Arsenic (As) | 0.5 | 2 | 25 |
| Barium (Ba) | 20 | 100 | 300 |
| Cadmium (Cd) | 0.04 | 1 | 5 |
| Total chromium (Cr) | 0.5 | 10 | 70 |
| Copper (Cu) | 2 | 50 | 100 |
| Mercury (Hg) | 0.01 | 0.2 | 2 |
| Molybdenum (Mo) | 0.5 | 10 | 30 |
| Nickel (Ni) | 0.4 | 10 | 40 |
| Lead (Pb) | 0.5 | 10 | 50 |
| Selenium (Se) | 0.1 | 0.5 | 7 |
| Zinc (Zn) | 4 | 50 | 200 |
| Chlorine | 800 | 1500 | 25000 |
| (in the form of | | | |
| chlorides Cl⁻) | | | |
| Fluorine | 10 | 150 | 500 |
| (in the form of | | | |
| fluoride F⁻) | | | |
| Sulfur | 1000 | 20000 | 50000 |
| (in the form of | | | |
| sulfate SO₄²⁻) | | | |

IWSI : Inert Waste Storage Installation
NHWSI: Non-Hazardous Waste Storage Installation
HWSI: Hazardous Waste Storage Installation
*Annex II of the decree of 12.12.2014
**Decision No. 2003/33/CE of 19.12.2002
***Annex I of the decree of 30.12.2002

If the concentration by weight of at least one of the polluting inorganic elements contained in the excavation sludge is greater than the HWSI limiting value indicated in Table 1, then the excavation sludge is regarded as highly contaminated. It is then stored in installations specifically dedicated to its decontamination, to the recovery and the valorisation of the polluting inorganic elements.

The procedure for determining the concentration by weight of the polluting inorganic elements in the excavation sludges is set by national standards. In France, they are the French standards NF EN 12457-2 (1 Dec. 2002) and NF EN 16192 (1 Mar. 2020). According to these standards, the amount of pollutant in an excavation sludge is determined by a physicochemical analysis of the composition of the leachate obtained on conclusion of a simulated leaching of said excavation sludge. According to these French standards, a leaching (well-known treatment with water which results in the dissolution of the soluble entities) of the excavation sludge is simulated at ambient temperature (20° C.±5° C.) for 24 hours. Then the leachate (residual liquid from the leaching) is analysed in order to determine the concentration by weight of the polluting inorganic elements in said leachate. This concentration by weight matches the concentration by weight of the polluting inorganic elements present in the excavation sludges.

The inventors have found, surprisingly, that, for some polluting inorganic elements, there is poor matching between their concentration by weight in the leachate and their concentration by weight in the excavation sludge. Indeed, their concentration by weight in the leachate can be much higher and thus does not match their concentration by weight in the excavation sludge.

This poor matching gives rise to poor classification of the excavation sludges. This poor classification is the cause of environmental problems because the excavation sludges are not stored in the storage installation matching their composition. This poor classification also presents economic problems. Indeed, the excavation sludge, the leachate of which exhibits a higher content of polluting inorganic materials than the concentration by weight actually present in said sludge, will be stored in a storage installation at a higher cost than its correct storage installation. In the light of the amount of excavation sludges to be stored during big jobs, this represents a not insignificant economic detail.

After numerous research studies, the inventors have found that this poor matching was caused by a change in the physicochemical properties of these polluting inorganic elements during the formation of the excavation sludges by the tunnelling machine. Specifically, this change in the physicochemical properties detrimentally affects the solubility in water of these polluting inorganic elements and thus detrimentally affects their concentration by weight in the leachate. For example, this change in the physicochemical properties can be the transformation of these inorganic elements into oxyanions. Indeed, this transformation increases the concentration of the polluting inorganic elements within the leachate because the solubility in water of the oxyanions is greater than the solubility in water of the uncharged inorganic elements.

The present disclosure is targeted at solving the problems related to the physicochemical changes in the polluting inorganic elements present in the excavation sludges.

### SUMMARY

Thus, a first subject-matter of the invention relates to a method of preparation of an excavation material comprising the following step:

a) inerting the excavation material in order to obtain an inerted material;

step a) being carried out by addition of an organic acid, of a complexing agent or of a diaminotetracarboxylic acid to the excavation material,

the complexing agent being chosen from a sugar alcohol, a cationic surface-active agent and their mixtures.

Advantageously, the inerting step a) makes it possible to limit the transformation of the inorganic elements present in the excavation material to give oxyanions. Thus, the concentration by weight of the inorganic elements in a leachate obtained from a sample of inerted material matches the concentration by weight of the inorganic elements in the excavation material.

Furthermore, the inerting step a) advantageously makes it possible to prevent the release of the inorganic polluting elements from the excavation material during the storage of said excavation material, for example, in a hazardous waste storage installation or during the valorisation of said excavation material as building material.

A second subject-matter of the invention is a method of determination of the concentration by weight of a polluting inorganic element included in an excavated material, said method of determination comprising the following steps:

b) leaching a sample of inerted material obtained during the inerting step a) of the method of preparation according to the first subject-matter of the invention in order to obtain a leachate, and

c) determination of the concentration by weight of the polluting inorganic element in the leachate.

Advantageously, the concentration by weight of the polluting inorganic element in the leachate, determined by the method of determination of the second subject-matter of the invention, matches, by virtue of the inerting step a) of the method of preparation according to the invention, the concentration by weight of this element in the excavation material.

The method of determination of the second subject-matter of the invention also makes it possible to direct the excavation material to the appropriate waste storage procedure or towards the appropriate valorisation procedure.

A third subject-matter of the invention is a method of storage of an excavation material comprising a step of storage of the inerted material obtained during the inerting step a) of the method of preparation according to the first subject-matter of the invention.

A fourth subject-matter of the invention is a method of valorisation of an inerted excavated material comprising a step of valorisation the inerted material obtained during the inerting step a) of the method of preparation according to the first subject-matter of the invention as building material.

### DETAILED DESCRIPTION

According to a first subject-matter of the invention, there is provided a method of preparation of an excavation material comprising the following step:

a) inerting the excavation material in order to obtain an inerted material; step a) being carried out by addition of an organic acid, of a complexing agent or of a diaminotetracarboxylic acid to the excavation material,

the complexing agent being chosen from a sugar alcohol, a cationic surface-active agent and their mixtures.

Within the meaning of the present patent application, the term “excavation material” (also referred to as “excavated material”) denotes a material excavated during civil engineering or building works, whether at the surface of the ground, for example during excavations or creations of foundations, or in the subsoil, for example during the digging of tunnels, caverns and galleries. Typically, the excavation material comprises:
loose rocks, such as gravel, sand, silt, clay and their mixtures;
crushed boulders;
materials originating from previous constructions or from polluted sites, such as landfill sites; or
excavation sludges.

According to one embodiment, the excavation material is an excavation sludge.

Typically, the excavation sludge can be produced by a tunnelling machine excavating a tunnel during construction of an underground railway line, of a train line or of a road.

According to a specific embodiment, the excavation sludge is extracted from the subsoil of Paris.

The inerting step a) is carried out by addition of a chemical entity chosen from an organic acid, a complexing agent and a diaminotetracarboxylic acid to the excavation material, in particular a sample of the excavation material, and then mixing of the chemical entity therewith. Typically, during step a), the chemical entity and the excavation material, in particular a sample of the excavation material, can be mixed in order to obtain a homogeneous mixture. The mixing can be carried out by mechanical stirring, kneading, injection, agitating, trituration and their combinations, in particular by kneading, injection and their combination.

Without wishing to be committed to any theory, the inventors are of the opinion that:
the organic acid makes it possible to reduce the pH of the excavation material and thus to prevent the transformation of certain inorganic elements into oxyanions,
the complexing agent makes it possible to complex the oxyanions and thus to prevent them from dissolving in the water during the leaching, and
the diaminotetracarboxylic acid combines the two effects.
   Thus, the concentration by weight of the inorganic elements in a leachate obtained from the sample of inerted material matches the concentration by weight of the inorganic elements in the excavation material.

According to the invention, the acid employed in step a) cannot be an inorganic acid, such as the phosphoric acid described in EP 1 341 728 or the sulfuric acid described in CA 2 423 515. Indeed, the inorganic element of an inorganic acid can be dissolved and entrained in the leachate obtained from a sample of inerted material so that the concentration by weight of inorganic elements present in the leachate may not match the concentration by weight of inorganic elements present in the excavation material. Furthermore, the inorganic element of an inorganic acid may be released in the form of a polluting inorganic element during the storage of the excavation material or during the valorisation of the excavation material as building material. This release may be toxic to the environment and hazardous by detrimentally affecting the properties of the building material.

Typically, the organic acid can be chosen from benzoic acid, ethanoic acid, methanoic acid, 3-carboxy-3-hydroxypentanedioic acid, 2-hydroxypropanoic acid, propanoic acid, butanoic acid, pentanoic acid, hexanoic acid, octanoic acid, heptanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, nonadecanoic acid, eicosanoic acid, docosanoic acid, 2-hydroxybenzoic acid, 2-mercaptopropanoic acid and their mixtures, in particular from ethanoic acid, propanoic acid and their mixture, very particularly be ethanoic acid.

In certain circumstances, the organic acid can be pentadecanoic acid.

Advantageously, the use of ethanoic acid makes it possible to limit the formation of oxyanions, in particular of molybdenum and sulfur oxyanions. It thus makes it possible to appropriately determine the concentration by weight of the polluting inorganic elements, in particular the concentration by weight of molybdenum and sulfur, in the excavation material.

Typically, the pH of the inerted material obtained during the inerting step a) by addition of the organic acid can be between 3 and 9, particularly between 4 and 8, more particularly between 5 and 6.

Advantageously, a pH in such ranges makes it possible to effectively limit, indeed even prevent, the transformation of certain inorganic elements into oxyanions.

Typically, the organic acid can be added to the excavated material so that the ratio by weight of the organic acid to the excavated material is between 0.1 g/kg and 50 g/kg, in particular between 1 g/kg and 40 g/kg, very particularly between 3 g/kg and 35 g/kg.

Advantageously, a ratio by weight in such value ranges makes it possible to obtain the abovementioned pH and thus to effectively limit, indeed even prevent, the transformation of certain inorganic elements into oxyanions.

A person skilled in the art will know how to adapt the ratio by weight according to the acid added to the excavated material.

The complexing agent is chosen from a sugar alcohol, a cationic surface-active agent and their mixture.

Mention may be made, as sugar alcohol, of alditol, sorbitol, mannitol, glycerol, xylitol, ribitol, lactitol, volemitol, erythritol, arabitol, maltitol, galactitol, threitol, functionalized glucitol, 1-deoxy-1-(methylamino)-D-glucitol or their mixtures, in particular alditol, 1-deoxy-1-(methylamino)-D-glucitol or their mixture, very particularly alditol or 1-deoxy-1-(methylamino)-D-glucitol.

In certain circumstances, the sugar alcohol can be lactitol.

The cationic surface-active agent can be chosen from oleyl betainate mesylate, protonated amines, quaternary ammoniums and their mixtures, in particular be oleyl betainate mesylate.

Behentrimonium methosulfate (BTMS) is an example of quaternary ammonium which can be employed in the inerting step a) of the method of preparation of the present invention.

Typically, the complexing agent can be added to the excavated material so that the ratio by weight of the complexing agent to the excavated material is between 0.01 mg/kg and 20 mg/kg, in particular between 0.05 mg/kg and 10 mg/kg, very particularly between 0.1 mg/kg and 5 mg/kg.

Advantageously, a ratio by weight in such ranges makes it possible to effectively complex oxyanions, in particular molybdenum and sulfur oxyanions. It thus makes it possible to limit, indeed even prevent, their dissolution in the water during the leaching. It also makes it possible to appropriately determine the concentration by weight of the polluting inorganic elements, in particular the concentration by weight of molybdenum and sulfur, in the excavation material.

A person skilled in the art will know how to adapt the ratio by weight according to the complexing agent added to the excavated material.

Typically, the diaminotetracarboxylic acid can be chosen from ethylenediaminetetraacetic acid (EDTA), ethylene glycol-bis(β-aminoethyl ether)-N,N,N′,N′-tetraacetic acid (EGTA), EDTA derivatives and their mixtures, in particular EDTA, EGTA and their mixture, very particularly be EDTA.

EDTA advantageously makes it possible to effectively limit, indeed even prevent, the formation of oxyanions and to effectively complex the possible oxyanions formed, in particular molybdenum and sulfur oxyanions, in order to prevent them from dissolving in the water during the leaching. It thus makes it possible to appropriately determine the concentration by weight of the polluting inorganic elements, in particular the concentration by weight of molybdenum and sulfur, in the excavation material.

Typically, the diaminotetracarboxylic acid can be added to the excavated material so that the ratio by weight of the diaminotetracarboxylic acid to the excavated material can be between 0.01 mg/kg and 20 mg/kg, in particular between 0.1 mg/kg and 10 mg/kg, more particularly between 0.20 mg/kg and 5 mg/kg.

Advantageously, a ratio by weight in such ranges makes it possible to effectively prevent the transformation of certain inorganic elements into oxyanions and to effectively complex the possible oxyanions formed in order to prevent them from dissolving in the water during the leaching.

A person skilled in the art will know how to adapt the ratio by weight according to the diaminotetracarboxylic acid added to the excavated material.

According to a first specific embodiment, the inerting step a) is carried out with ethanoic acid and the ratio by weight of the ethanoic acid to the excavation material can be between 3 g/kg and 35 g/kg.

According to a second specific embodiment, the inerting step a) is carried out with EDTA and the ratio by weight of the EDTA to the excavation material can be between 0.2 mg/kg and 2.5 mg/kg.

According to a third specific embodiment, the inerting step a) is carried out with 1-deoxy-1-(methylamino)-D-glucitol and the ratio by weight of 1-deoxy-1-(methylamino)-D-glucitol to the excavation material can be between 0.1 mg/kg and 3.5 mg/kg.

According to a fourth specific embodiment, the inerting step a) is carried out with oleyl betainate mesylate and the ratio by weight of the oleyl betainate mesylate to the excavation material can be between 0.1 mg/kg and 3 mg/kg.

According to a fifth specific embodiment, the inerting step a) is carried out with BTMS and the ratio by weight of the BTMS to the excavation material can be between 0.5 mg/kg and 1.5 mg/kg.

According to a sixth specific embodiment, the inerting step a) is carried out with EGTA and the ratio by weight of the EGTA to the excavation material can be between 0.5 mg/kg and 25 mg/kg, in particular between 4 mg/kg and 6 mg/kg.

According to a seventh specific embodiment, the inerting step a) is carried out with lactitol and the ratio by weight of the lactitol to the excavation material can be between 0.05 mg/kg and 10 mg/kg, in particular between 1 mg/kg and 2 mg/kg.

According to an eighth specific embodiment, the inerting step a) is carried out with pentadecanoic acid and the ratio by weight of the pentadecanoic acid to the excavation material can be between 0.05 g/kg and 1 g/kg, in particular between 0.07 g/kg and 0.2 g/kg.

Typically, the excavation material may have undergone a step of preparation before the inerting step a), such as a grinding step, optionally followed by a sieving step.

One advantage of the method of preparation according to the invention as defined above is that the concentration by weight of the inorganic elements in a leachate obtained from a sample of inerted material matches the concentration by weight of the inorganic elements in the excavation material. The excavation material can thus be intended to be analysed in order to determine the concentration by weight of a polluting inorganic element in the excavation material.

Thus, according to one embodiment, the excavation material is to be analysed and step a) is carried out on a sample of the excavation material in order to obtain an inerted material sample.

Moreover, a second subject-matter of the invention is a method of determination of the concentration by weight of a polluting inorganic element included in an excavated material, said method of determination comprising the following steps:

b) leaching a sample of inerted material obtained during the inerting step a) of the method of preparation as defined above in order to obtain a leachate, and

c) determination of the concentration by weight of the polluting inorganic element in the leachate.

Within the meaning of the present patent application, the term “polluting inorganic element” denotes an inorganic element chosen from the groups of the alkali metals, alkaline earth metals, lanthanide metals, actinide metals, transition metals, p-block metals, semimetals, non-metals and halogens, in particular groups of the alkaline earth metals, transition metals, p-block metals, semimetals, non-metals and halogens. Typically, the polluting inorganic element can be chosen from Al, As, Ba, Ca, Cd, CI, Cr, Cu, F, Fe, Hg, K, Mg, Mo, Ni, Nb, P, Pb, Rb, S, Sb, Se, Si, Sr, Ti, V, Zn, Zr, in particular chosen from As, Cr, F, Mo, Nb, S, Sb, Se, V, very particularly chosen from F, Mo, S, Sb and Se. The polluting inorganic element can be detected as molecule or as ionic chemical compound, such as oxyanions, fluorides and sulfates.

When the excavation material is extracted from the subsoil of Paris, then the polluting inorganic element can be chosen from selenium (Se), molybdenum (Mo), antimony (Sb), sulfur (in the ionic chemical compound form of sulfates (SO₄²⁻) and fluorine (in the ionic chemical compound form of fluorides F⁻). Indeed, recent analyses of the subsoil of Paris have demonstrated that the concentration by weight of the other polluting inorganic elements is far below the IWSI limiting value indicated in Table 1.

According to a first embodiment of the method of determination according to the second subject-matter of the invention,

the leaching step b) can comprise the following sub-steps:
b1) solid/liquid extraction of the inerted material sample obtained during the inerting step a) with a liquid solvent, in order to obtain a mixture comprising a liquid fraction and a solid fraction,
b2) filtration of the liquid fraction obtained during the extraction step b1), in order to recover a filtered liquid fraction, and

step c) can be carried out by analysing the filtered liquid fraction recovered during step b2) in order to determine the concentration by weight of the polluting inorganic element;

step b1) being carried out at a temperature T_{extraction} of from 65° C. to 200° C.

Typically, the extraction step b1) is carried out with a liquid solvent chosen from water, an aqueous solution, an organic solvent, an inorganic solvent and their mixtures.

Typically, the organic solvent is a volatile organic solvent, in particular a volatile organic solvent chosen from methanol, acetone, hexane, acetonitrile, ethanol, an ether, dimethyl sulfoxide, 2-hexanone or their mixture.

Typically, the solvent used can be water.

Typically, the ratio of the volume of solvent to the dry weight of the sample of the inerted material during the extraction step b1) is from 5 ml/g to 20 ml/g, in particular from 7 ml/g to 15 ml/g, very particularly from 9.5 ml/g to 10.5 ml/g.

Typically, the sample of the inerted material and/or the solvent can be heated to the temperature T_{extraction}, then they can be brought into contact in order to carry out the extraction step b1).

Typically, the sample of the inerted material can be brought into contact with the solvent in order to obtain a mixture and then this mixture can be heated up to the temperature T_{extraction} in order to carry out the extraction step b1).

Typically, the sample of the inerted material and/or the solvent can be heated to the temperature T1, which is lower than the temperature T_{extraction}, then they can be brought into contact in order to obtain a mixture, this mixture can subsequently be heated up to the temperature T_{extraction} so as to carry out the extraction step b1).

Typically, the temperature T1 can be from 40° C. to 80° C., in particular from 50° C. to 70° C., very particularly from 55° C. to 65° C.

Typically, the solvent and the sample of the inerted material can be brought into contact so as to improve the kinetics of homogenization of the sample/liquid solvent mixture and thus to reduce the duration of the extraction step b1).

As the extraction step b1) is carried out at T_{extraction}, step b1) can be carried out at a pressure P_{extraction} in order to keep the solvent in liquid form. Typically, P_{extraction} can be from 1 bar to 10 bar, in particular from 1.2 bar to 5 bar, very particularly from 1.6 bar to 2.5 bar.

Advantageously, carrying out the extraction step b1) under the pressure P_{extraction} makes it possible for the liquid solvent to be introduced more rapidly into the sample of the inerted material than at 1 bar. For this reason, the duration of the extraction step b1) is reduced.

According to one embodiment, the sample of the inerted material can undergo, before the extraction step b1), a preparation step, such as a grinding step, in order to obtain a ground sample, and/or a drying step, in order to obtain a dry sample.

The grinding step makes it possible to reduce the particle size of the sample of the inerted material to be analysed and to improve its homogeneity, which makes it possible to facilitate the solid/liquid extraction and thus to reduce the duration of the extraction step b1).

Typically, the particle size of the ground sample can be less than 1 cm, in particular from 5 μm to 150 μm, more particularly from 20 μm to 100 μm.

The particle size of the ground sample can typically be determined by sieving.

The drying step can make it possible to dry the sample of inerted material in order for the dry sample to typically exhibit a solids content, or dryness, of from 70% to 100%, in particular from 75% to 90%, very particularly from 78% to 82%.

Within the meaning of the present patent application, the term “solids content” is the ratio of the dry weight of the dry sample to the weight of the sample of inerted material before drying, the dry weight of the dry sample being measured after drying approximately 30 grams of sample of inerted material at 130° C. for 30 minutes.

Typically, the extraction step b1) is carried out in a reactor comprising:
an extraction chamber appropriate for receiving the sample of the inerted material,
two liquid inlet ports and one liquid outlet port,
   in which:
the two liquid inlet ports are fluidically connected to the extraction chamber and positioned on either side of the extraction chamber, and
the liquid outlet port is fluidically connected to the extraction chamber.

Within the meaning of the present invention, the term “liquid inlet port” is understood to mean any element appropriate for introducing the solvent into the extraction chamber of the reactor.

Within the meaning of the present invention, the term “liquid outlet port” is understood to mean any element appropriate for extracting the liquid fraction from the extraction chamber of the reactor.

The position of the two liquid inlet ports, on either side of the extraction chamber, makes it possible to improve the homogeneity of the sample/solvent mixture. Advantageously, this makes it possible to facilitate the solid/liquid extraction and thus to reduce the duration of the extraction step b1).

The liquid fraction obtained during the extraction step b1) comprises the inorganic pollutant(s) included in the sample of the inerted material. The analysis of this liquid fraction makes it possible to determine the concentration by weight of each of the polluting inorganic elements contained in the sample of the excavation material.

Typically, the filtration step b2) is carried out using a filter.

Within the meaning of the present invention, the term “filter” is understood to mean any element through which the liquid fraction can pass and retain the solid fraction.

Typically, the material of the filter is chosen from a filtration membrane, glass fibre, cellulose, PTFE, nylon, PMMA, PE, sulfone-based materials, acrylic materials or fluorinated materials, in particular cellulose.

The material of the filter can be hydrophilic or hydrophobic. According to a specific embodiment, the material of the filter is hydrophilic.

Typically, the filter exhibits a porosity of less than 100 μm, in particular of less than 75 μm, more particularly of less than 55 μm.

The filter can comprise several filters of different porosities.

According to one embodiment, the filter can comprise:
two filters with one and the same porosity which is less than 100 μm, in particular less than 75 μm, more particularly less than 55 μm, and
a third filter, between these two filters, with a different porosity of between 0.1 μm and 5 μm, in particular between 0.2 μm and 1 μm, more particularly between 0.25 μm and 0.35 μm.

Typically, the ratio of the volume of the sample of the excavation material to the filtration surface area of the filter is less than 10 cm, in particular from 0.1 cm to 5 cm, very particularly from 0.5 cm to 1 cm.

Advantageously, the filter does not become blocked during the filtration step b2) when the ratio of the volume of excavation material to the filtration surface area of the filter is within the above ranges.

Typically, the filtration step b2) is carried out by applying an excess pressure to the mixture comprising the liquid fraction and the solid fraction in order to force said liquid fraction through the filter, or by applying a negative pressure to the mixture comprising the liquid fraction and the solid fraction in order to suck said liquid fraction through the filter, in particular by applying an excess pressure.

A person skilled in the art knows if he/she has to apply an excess pressure or a negative pressure to the mixture comprising a liquid fraction and a solid fraction in order to carry out the filtration step b2).

Typically, the excess pressure applied to the mixture is greater than 1 bar, in particular from 1.2 bar to 5 bar, very particularly from 1.6 bar to 2.5 bar.

Typically, the negative pressure applied to the mixture is less than 1 bar, in particular from 0.2 bar to 0.5 bar.

According to a very specific embodiment, the filtration step b2) is carried out under vacuum.

Although the filtration time depends on the parameters described above, it is typically less than 10 minutes.

When the extraction step b1) is carried out in the reactor described above, the filter is positioned in said reactor so that the liquid outlet port is fluidically connected to the extraction chamber through the filter.

Typically, the filtered liquid fraction can be analysed during the analysis step c) by liquid-phase ion chromatography assay, by colorimetric assay, by potentiometric assay, by pH-metric assay, by absorption spectrometry, by inductively coupled plasma atomic emission spectroscopy (ICP-AES), by inductively coupled plasma mass spectrometry (ICP-MS), by flame ionization spectrometry (FID), by flame emission spectrometry or by UV spectrophotometry, in particular by liquid-phase ion chromatography assay, by potentiometric assay or by inductively coupled plasma mass spectrometry (ICP-MS).

A person skilled in the art will know how to choose the analytical technique to be employed according to the inorganic polluting element, the concentration by weight of which he/she wishes to determine.

According to a specific embodiment, the concentration by weight of the metals, such as molybdenum, selenium and antimony, is determined by inductively coupled plasma atomic emission spectroscopy (ICP-AES) and/or inductively coupled plasma mass spectrometry (ICP-MS), in particular the inductively coupled plasma atomic emission spectroscopy (ICP-AES) according to Standard NF EN ISO 11885 and/or the inductively coupled plasma mass spectrometry (ICP-MS) according to Standard NF EN ISO 17294-2.

According to a specific embodiment, the concentration by weight of the anions, such as the bromide, chloride, fluoride, nitrate, nitrite, orthophosphate and sulfate anions, can be determined by UV spectrophotometry and/or by liquid-phase ion chromatography assay, in particular by UV spectrophotometry according to Standard NF ISO 15923-1 and/or liquid-phase ion chromatography assay according to Standard NF EN ISO 10304-1.

According to a specific embodiment, the concentration by weight of the fluoride ion can be determined by potentiometric assay, in particular the potentiometric assay according to Standard NF T90-004.

The inductively coupled plasma atomic emission spectroscopy (ICP-AES) according to Standard NF EN ISO 11885, the inductively coupled plasma mass spectrometry (ICP-MS) according to Standard NF EN ISO 17294-2, the UV spectrophotometry according to Standard NF ISO 15923-1, the liquid-phase ion chromatography assay according to Standard NF EN ISO 10304-1 and the potentiometric assay according to Standard NF T90-004 are the analytical techniques listed in French Standard NF EN 16192 for determining the concentration by weight of each of the polluting inorganic elements contained in the excavation materials.

When these analytical techniques are employed in step c) of analysis of the filtered liquid fraction, then this analysis step is similar to that of French Standard NF EN 16192, i.e. 60 minutes.

Advantageously, the method of determination according to the first embodiment, referred to as accelerated leaching, thus makes it possible to determine, in a few minutes, each of the inorganic polluting elements contained in a sample of excavation material directly on the site of extraction of the excavation materials. Furthermore, the present inventors have found that the concentrations by weight determined by the method of determination according to the first embodiment could be correlated with the concentrations by weight determined according to the analytical techniques listed in French Standard NF EN 16192.

According to a second embodiment of the method of determination according to the second subject-matter of the invention, step b) can be carried out according to French Standard NF EN 12457-2 (1 Dec. 2002) and step c) can be carried out according to French Standard NF EN 16192 (1 Mar. 2020).

Advantageously, the results obtained by the method of determination according to the first embodiment and by the method of determination according to the second embodiment are of the same order of magnitude. However, the method of determination according to the first embodiment makes it possible to obtain results more rapidly than the method of determination according to the second embodiment.

Another advantage of the method of preparation according to the invention as defined above is that of preventing the release of the inorganic polluting elements from the excavation material during the storage of said excavation material.

Thus, a third subject-matter of the invention is a method of storage of an excavation material comprising a step of storage of the inerted material obtained during the inerting step a) of the method of preparation according to the invention as defined.

Depending on the concentration of inorganic polluting elements included in the excavation material, the inerted material can be stored in an Inert Waste Storage Installation, a Non-Hazardous Waste Storage Installation or a Hazardous Waste Storage Installation. The storage installation can be chosen by virtue of the method of determination as defined above.

The storage step depends on the installation in which the inerted material is stored. Thus, the storage step can be appropriate to storage in an Inert Waste Storage Installation, in a Non-Hazardous Waste Storage Installation or in a Hazardous Waste Storage Installation, in particular in a Hazardous Waste Storage Installation.

The storage of material in one of these three installations is known to a person skilled in the art. He/She will thus know how to carry out the storage step.

Another advantage of the method of preparation according to the invention as defined above is that of preventing the release of the inorganic polluting elements from the excavation material during the valorisation of said excavation material as building material.

A fourth subject-matter of the invention is thus a method of valorisation of an inerted excavated material comprising a step of valorisation the inerted material obtained during the inerting step a) of the method of preparation according to the invention as defined above as building material.

Typically, the building material can be a backfill or an aggregate, in particular a backfill, an aggregate for concrete or an aggregate for a bituminous mix.

Within the meaning of the present patent application, the term “backfill” denotes a building material intended to raise a piece of land, fill in a hollow or fill in the voids from a mine operation.

Within the meaning of the present patent application, the term “aggregate” denotes a building material used for the fulfilment of civil engineering works, road works or building works.

An aggregate for concrete or an aggregate for a bituminous mix are aggregate examples.

Within the meaning of the present patent application, the term “aggregate for a bituminous mix” denotes an aggregate used for the preparation of bitumen.

Within the meaning of the present patent application, the term “aggregate for concrete” denotes an aggregate used for the preparation of concretes.

The valorisation step can comprise a step of production of a building material from the inerted material.

Typically, the production step can comprise one or more sub-steps of shaping the inerted material, the sub-step(s) being appropriate to the building material, in particular to the backfill or to the aggregate, more particularly to the backfill, to the aggregate for concrete or to the aggregate for a bituminous mix.

The choice of the building material depends on the concentration of polluting inorganic elements included in the excavation material. Thus, the production step, the sub-step(s) of shaping the inerted material can be chosen by virtue of the method of determination as defined above.

The invention will be described in more detail with the help of the following examples given by way of illustration alone.

### EXAMPLES

Examples 1 to 8 illustrate the results obtained during the determination of the concentration by weight of sulfur (S, in the ionic chemical compound form of sulfates SO₄²⁻) according to the methods of the invention in excavation sludges which have undergone various steps of rendering inert according to the invention.

Examples 1 to 8 demonstrate that the concentration by weight of sulfur (S, in the ionic chemical compound form of sulfates SO₄²⁻) in the leachate from the inerted samples is a better match with the true concentration by weight of sulfur of these samples than the concentration by weight of sulfur in the leachate from the non-inerted sample.

### Example 1: EDTA

Three samples of dried, ground and sieved sludges are analysed by X-ray fluorescence spectrometry in order to determine the true concentration by weight of sulfur of these samples. The analyses were carried out with the portable ThermoFisher XL3T GOLD spectrometer. The X-ray source is made of silver, and the electrons are accelerated by a voltage of 50 kV. 5 g of each of the samples were analysed, under air, for 15 minutes per filter between 0 and 20 keV. The total acquisition time is 30 min.

EDTA is subsequently added to two of the three samples according to the ratios shown in Table 2 below; the mixture obtained is subsequently homogenized. EDTA is not added to the third sample (comparative example).

Each of the three samples is subsequently analysed by accelerated leaching according to the following protocol:

A known weight (approximately 30 g) of a mixture is dried at 130° C. for 30 minutes in order to determine the solids of said sample.

A weight of sample equivalent to 4 g of solids of this sample is added to a Q-Cup cylinder of the Energized Dispersive Guided Extraction (EDGE) device from CEM. The Q-Cup cylinder is equipped with a superimposition of three Q-Disc filters: A Q-Disc C9 filter made of hydrophilic cellulose, the porosity of which is 55 μm, a Q-Disc G1 filter made of glass fibres, the porosity of which is 0.3 μm, and a second Q-Disc C9 filter.

The sample is subsequently heated to the temperature T₁ of 60° C. and then the solvent, which is water, is introduced into the Q-Cup cylinder on either side of the sample.

The mixture is subsequently heated to the temperature T_{extraction} of 100° C. This temperature Textraction is maintained for 30 seconds. The extraction thus lasts 30 seconds.

After the 30 seconds, the mixture is no longer heated, so that the temperature of the mixture decreases. The liquid fraction is subsequently filtered through the Q-Disc filter by application of an excess pressure of 2.2 bar in the Q-Cup cylinder.

The filtered liquid fraction is subsequently analysed by liquid-phase ion chromatography assay according to Standard NF EN ISO 10304-1 in order to determine the concentration by weight of sulfur. This analytical technique is listed in French Standard NF EN 16192.

TABLE 2

| Concentration by weight of | Concentration by weight |
|---|---|
| sulfur (in sulfate form) | of sulfur (in sulfate |
| determined by X-ray | form) determined |
| fluorescence spectrometry | by accelerated leaching |
| 395 mg/kg | 1140 mg/kg |
| | (Comparative example: |
| | no addition of EDTA) |
| 514 mg/kg | 669 mg/kg |
| | (EDTA/sludge ratio |
| | by weight: 0.55 mg/kg) |
| 405 mg/kg | 413 mg/kg |
| | (EDTA/sludge ratio by |
| | weight: 2.22 mg/kg) |

Table 2 demonstrates that the addition of EDTA makes it possible to greatly reduce the disparity between the true concentration by weight of sulfur determined by X-ray fluorescence spectrometry and the concentration by weight of sulfur determined by accelerated leaching. Indeed, the discrepancy is 188% without addition of EDTA, whereas it can be equal to 2% with the addition of EDTA.

### Example 2: Ethanoic Acid

The procedure is identical to that of Example 1, the differences being that EDTA is replaced with ethanoic acid and that the ethanoic acid/sludges ratios have been adjusted as indicated in Table 3 below.

Table 3 demonstrates that ethanoic acid makes it possible to greatly reduce the disparity between the true concentration by weight of sulfur determined by X-ray fluorescence spectrometry and the concentration by weight of sulfur determined by accelerated leaching. Indeed, the discrepancy is 50% without addition of ethanoic acid, whereas it can be approximately 10% with the addition of ethanoic acid.

TABLE 3

| Concentration by weight of | Concentration by weight |
|---|---|
| sulfur (in sulfate form) | of sulfur (in sulfate |
| determined by X-ray | form) determined |
| fluorescence spectrometry | by accelerated leaching |
| 328 mg/kg | 487 mg/kg |
| | (Comparative example: |
| | no addition of |
| | ethanoic acid) |
| 604 mg/kg | 555 mg/kg |
| | (Ethanoic acid/sludge |
| | ratio by weight: |
| | 3.3 g/kg, |
| | pH of the mixture: 5.50) |
| 382 mg/kg | 346 mg/kg |
| | (Ethanoic acid/sludge |
| | ratio by weight: |
| | 19 g/kg, |
| | pH of the mixture: 5.15) |

### Example 3: sugar alcohol, 1-deoxy-1-(methylamino)-D-glucitol

The procedure is similar to that of Example 1, the differences being that EDTA is replaced with 1-deoxy-1-(methylamino)-D-glucitol and that the 1-deoxy-1-(methylamino)-D-glucitol/sludge ratios by weight have been adjusted as indicated in Table 4 below.

Table 4 demonstrates that 1-deoxy-1-(methylamino)-D-glucitol makes it possible to greatly reduce the disparity between the true concentration by weight of sulfur determined by X-ray fluorescence spectrometry and the concentration by weight of sulfur determined by accelerated leaching. Indeed, the discrepancy is 188% without addition of 1-deoxy-1-(methylamino)-D-glucitol; on the other hand. it can be less than 25% with the addition of 1-deoxy-1-(methylamino)-D-glucitol.

TABLE 4

| Concentration by weight of | Concentration by weight |
|---|---|
| sulfur (in sulfate form) | of sulfur (in sulfate |
| determined by X-ray | form) determined |
| fluorescence spectrometry | by accelerated leaching |
| 395 mg/kg | 1140 mg/kg |
| | (Comparative example: |
| | no addition of |
| | sugar alcohol) |
| 400 mg/kg | 655 mg/kg |
| | (Sugar alcohol/sludge |
| | ratio by weight: |
| | 0.75 mg/kg |
| 440 mg/kg | 541 mg/kg |
| | (Sugar alcohol/sludge |
| | ratio by weight: |
| | 1.50 mg/kg) |

### Example 4: Cationic Surface-Active Agent, Oleyl Betainate Mesylate

The procedure is similar to that of Example 1, the differences being that EDTA is replaced with oleyl betainate mesylate and that the oleyl betainate mesylate/sludge ratios by weight have been adjusted as indicated in Table 5 below.

Table 5 demonstrates that oleyl betainate mesylate makes it possible to greatly reduce the disparity between the true concentration by weight of sulfur determined by X-ray fluorescence spectrometry and the concentration by weight of sulfur determined by accelerated leaching. Indeed, the discrepancy is 188% without addition of oleyl betainate mesylate; on the other hand, it can be less than 10% with the addition of oleyl betainate mesylate.

TABLE 5

| Concentration by weight of | Concentration by weight |
|---|---|
| sulfur (in sulfate form) | of sulfur (in sulfate |
| determined by X-ray | form) determined |
| fluorescence spectrometry | by accelerated leaching |
| 395 mg/kg | 1140 mg/kg |
| | (Comparative example: |
| | no addition of oleyl |
| | betainate mesylate) |
| 430 mg/kg | 620 mg/kg |
| | (Oleyl betainate mesylate/ |
| | sludge ratio by |
| | weight: 0.1 mg/kg) |
| 427 mg/kg | 586 mg/kg |
| | (Oleyl betainate mesylate/ |
| | sludge ratio by |
| | weight: 0.3 mg/kg) |
| 426 mg/kg | 506 mg/kg |
| | (Oleyl betainate mesylate/ |
| | sludge ratio by |
| | weight: 0.6 mg/kg) |
| 434 mg/kg | 465 mg/kg |
| | (Oleyl betainate mesylate/ |
| | sludge ratio by |
| | weight: 0.7 mg/kg) |
| 424 mg/kg | 402 mg/kg |
| | (Oleyl betainate mesylate/ |
| | sludge ratio by |
| | weight: 2.7 mg/kg) |

### Example 5: EGTA

The procedure is similar to that of Example 1, the differences being that EDTA is replaced with EGTA and that the EGTA/sludge ratios by weight have been adjusted as indicated in Table 6 below.

Table 6 demonstrates that EGTA makes it possible to greatly reduce the disparity between the true concentration by weight of sulfur determined by X-ray fluorescence spectrometry and the concentration by weight of sulfur determined by accelerated leaching. Indeed, the discrepancy is 40% without addition of EGTA; on the other hand, it is approximately 11% with the addition of EGTA.

TABLE 6

| Concentration by weight of | Concentration by weight |
|---|---|
| sulfur (in sulfate form) | of sulfur (in sulfate |
| determined by X-ray | form) determined |
| fluorescence spectrometry | by accelerated leaching |
| 440 mg/kg | 747 mg/kg |
| | (Comparative example: |
| | no addition of |
| | EGTA) |
| 495 mg/kg | 556 mg/kg |
| | (EGTA/sludge ratio |
| | by weight: |
| | 5.55 mg/kg |

### Example 6: Cationic Surfactant, Behentrimonium Methosulfate (BTMS)

The procedure is similar to that of Example 1, the differences being that EDTA is replaced with BTMS and that the BTMS/sludge ratio by weight has been adjusted as indicated in Table 7 below.

Table 7 demonstrates that BTMS makes it possible to reduce the disparity between the true concentration by weight of sulfur determined by X-ray fluorescence spectrometry and the concentration by weight of sulfur determined by accelerated leaching. Indeed, the discrepancy is 40% without addition of BTMS; on the other hand, it is approximately 16% with the addition of BTMS.

TABLE 7

| Concentration by weight of | Concentration by weight |
|---|---|
| sulfur (in sulfate form) | of sulfur (in sulfate |
| determined by X-ray | form) determined |
| fluorescence spectrometry | by accelerated leaching |
| 440 mg/kg | 747 mg/kg |
| | (Comparative example: |
| | no addition of |
| | BTMS) |
| 498 mg/kg | 591 mg/kg |
| | (BTMS/sludge ratio |
| | by weight: |
| | 0.38 mg/kg |

### Example 7: Sugar Alcohol, Lactitol

The procedure is similar to that of Example 1, the differences being that EDTA is replaced with lactitol and that the lactitol/sludge ratio by weight has been adjusted as indicated in Table 8 below.

Table 8 demonstrates that lactitol makes it possible to greatly reduce the disparity between the true concentration by weight of sulfur determined by X-ray fluorescence spectrometry and the concentration by weight of sulfur determined by accelerated leaching. Indeed, the discrepancy is 40% without addition of lactitol; on the other hand, it is approximately 1% with the addition of lactitol.

TABLE 8

| Concentration by weight of | Concentration by weight |
|---|---|
| sulfur (in sulfate form) | of sulfur (in sulfate |
| determined by X-ray | form) determined |
| fluorescence spectrometry | by accelerated leaching |
| 440 mg/kg | 747 mg/kg |
| | (Comparative example: |
| | no addition of |
| | lactitol) |
| 470 mg/kg | 475 mg/kg |
| | (lactitol/sludge ratio |
| | by weight: |
| | 1.5 mg/kg) |

### Example 8: Pentadecanoic Acid

The procedure is similar to that of Example 1, the differences being that EDTA is replaced with pentadecanoic acid and that the pentadecanoic acid/sludge ratio by weight has been adjusted as indicated in Table 9 below.

Table 9 demonstrates that pentadecanoic acid makes it possible to greatly reduce the disparity between the true concentration by weight of sulfur determined by X-ray fluorescence spectrometry and the concentration by weight of sulfur determined by accelerated leaching. Indeed, the discrepancy is 40% without addition of pentadecanoic acid; on the other hand, it is approximately 1% with the addition of pentadecanoic acid.

TABLE 9

| Concentration by weight of | Concentration by weight |
|---|---|
| sulfur (in sulfate form) | of sulfur (in sulfate |
| determined by X-ray | form) determined |
| fluorescence spectrometry | by accelerated leaching |
| 440 mg/kg | 747 mg/kg |
| | (Comparative example: |
| | no addition of |
| | pentadecanoic acid) |
| 498 mg/kg | 502 mg/kg |
| | (pentadecanoic acid/ |
| | sludge ratio by weight: |
| | 0.1 g/kg) |

1. A method of preparation of an excavation material comprising the following step:
a) inerting the excavation material in order to obtain an inerted material;
step a) being carried out by addition of an organic acid, of a complexing agent or of a diaminotetracarboxylic acid to the excavation material,
the complexing agent being chosen from a sugar alcohol, a cationic surface-active agent and their mixtures.

2. The method of preparation according to claim 1, in which the organic acid is chosen from benzoic acid, ethanoic acid, methanoic acid, 3-carboxy-3-hydroxypentanedioic acid, 2-hydroxypropanoic acid, propanoic acid, butanoic acid, pentanoic acid, hexanoic acid, octanoic acid, heptanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, nonadecanoic acid, eicosanoic acid, docosanoic acid, 2-hydroxybenzoic acid, 2-mercaptopropanoic acid and their mixtures.

3. The method of preparation according to claim 1, in which the diaminotetracarboxylic acid is chosen from ethylenediaminetetraacetic acid (EDTA), ethylene glycol-bis(β-aminoethyl ether)-N,N,N′,N′-tetraacetic acid (EGTA), ethylenediaminetetraacetic acid (EDTA) derivatives and their mixtures.

4. The method of preparation according to claim 1, in which the sugar alcohol is chosen from alditol, sorbitol, mannitol, glycerol, xylitol, ribitol, lactitol, volemitol, erythritol, arabitol, maltitol, galactitol, threitol, functionalized glucitol, 1-deoxy-1-(methylamino)-D-glucitol and their mixtures.

5. The method of preparation according to claim 1, in which the cationic surface-active agent is chosen from oleyl betainate mesylate, protonated amines, quaternary ammoniums and their mixtures.

6. The method of preparation according to claim 1, in which the excavation material is to be analysed and step a) is carried out on a sample of the excavation material in order to obtain an inerted material sample.

7. A method of determination of the concentration by weight of a polluting inorganic element included in an excavated material, said method of determination comprising the following steps:
b) leaching a sample of inerted material obtained during the inerting step a) of the method of preparation as defined in claim 6 in order to obtain a leachate, and
c) determination of the concentration by weight of the polluting inorganic element in the leachate.

8. The method of determination according to claim 7, in which:
the leaching step b) comprises the following sub-steps:
b1) solid/liquid extraction of the inerted material sample obtained during the inerting step a) with a liquid solvent, in order to obtain a mixture comprising
a liquid fraction and a solid fraction,
b2) filtration of the liquid fraction obtained during the extraction step b1), in order to recover a filtered liquid fraction, and
step c) is carried out by analysing the filtered liquid fraction recovered during step b2) in order to determine the concentration by weight of the polluting inorganic element;
step b1) being carried out at a temperature T_{extraction} of from 65° C. to 200° C.

9. The method of determination according to claim 7, in which step b) is carried out according to French Standard NF EN 12457-2 (1 Dec. 2002) and step c) is carried out according to French Standard NF EN 16192 (1 Mar. 2020).

10. A method of storage of an excavation material comprising a step of storage of the inerted material obtained during the inerting step a) of the method of preparation as defined in claim 1.

11. The method of storage according to claim 10, in which the step of storage is appropriate to storage in an Inert Waste Storage Installation, in a Non-Hazardous Waste Storage Installation or in a Hazardous Waste Storage Installation.

12. A method of valorisation of an inerted excavated material comprising a step of valorisation the inerted material obtained during the inerting step a) of the method of preparation as defined in claim 1 as building material.

13. The method according to claim 12, in which the building material is a backfill or an aggregate.

14. The method according to claim 12, in which the step of valorisation comprises a step of production of a building material from the inerted material.

15. The method according to claim 14, in which the production step comprises one or more sub-steps of shaping the inerted material, the sub-step(s) being appropriate to the building material.
